(19) United States
(12) Patent Application Publication
(10) Pub. No.: US 2022/0296943 A1
(43) Pub. Date: Sep. 22, 2022

(54) NOZZLE WITH ADJUSTABLE SPRAY

(71) Applicant: HEN Nozzles Inc., Castro Valley, CA (US)

(72) Inventors: Sunny SETHI, Castro Valley, CA (US); Nicholas J. MCKIBBEN, Oakland, CA (US); Sagar BHATIA, Union City, CA (US)

(21) Appl. No.: 17/828,093

(22) Filed: May 31, 2022

Related U.S. Application Data
(63) Continuation-in-part of application No. 17/112,993, filed on Dec. 5, 2020.
Application No. 17/112,993 is a continuation-in-part of application No. 16/595,218, filed on Oct. 7, 2019, now abandoned.
Application No. 16/595,218 is a continuation of application No. 17/112,990, filed on Dec. 5, 2020.
Application No. 17/112,990 is a continuation-in-part of application No. 16/595,218, filed on Oct. 7, 2019, now abandoned.
Application No. 16/595,218 is a continuation-in-part of application No. PCT/US2021/038393, filed on Jun. 22, 2021.
Application No. PCT/US2021/038393 is a continuation of application No. 17/112,990, filed on Dec. 5, 2020.
(60) Provisional application No. 62/880,567, filed on Jul. 30, 2019.
(60) Provisional application No. 62/880,567, filed on Jul. 30, 2019.

(51) Int. Cl. A62C 31/03; B05B 1/26; B05B 1/12; B05B 1/06

(52) U.S. Cl. CPC A62C 31/03; B05B 1/26; B05B 1/12; B05B 1/06

(57) ABSTRACT

In embodiments, an adjustable nozzle includes a nozzle body having an inlet section with an inlet opening, an outlet section with an outlet opening, and a fluid flow path extending from the inlet opening to the outlet opening; an adjustable spray restrictor segment located in the outlet section; and an actuator that displaces the adjustable spray restrictor segment toward and away from a center of the fluid flow path, thereby varying an effective width of the outlet opening to vary a pattern of fluid flowing from the fluid flow path through the outlet opening.

### GOVERNMENT LICENSE RIGHTS

This invention was made with government support under Contract No. 2127461 awarded by The National Science Foundation. The government has certain rights in the invention.

### TECHNICAL FIELD

The present invention relates to nozzles for spraying fluids, and more particularly to nozzles for spraying liquids under pressure that adjust the pattern of fluid exiting the nozzle.

### BACKGROUND

Nozzles are used to receive a fluid under pressure and control the shape and other characteristics of the stream of the fluid as it exits the nozzle. Such nozzles typically have an inlet opening, an exit opening that may take the form of a single orifice or multiple orifices, and a fluid flow path extending between the inlet opening and the exit opening. The inlet opening may include a fitting, which may be circular in cross section, for connecting the nozzle to a complementary fitting on a tank, flexible hose, or pipe.

Nozzles frequently are designed to increase the velocity of the fluid entering the nozzle to project the fluid stream exiting the nozzle in a long trajectory. This is achieved by providing the nozzle with a constriction in the fluid flow path. The constriction may take the form of a decrease in cross-sectional area from the nozzle inlet opening to the exit opening and/or an orifice or other restriction in the fluid flow path that effectively reduces the cross-sectional area of fluid flow. Providing such a constriction to fluid flow under constant pressure and constant volume flow rate results in the increase in fluid flow velocity. In some nozzles, the nozzle outlet orifice itself is reduced in cross-sectional area relative to the nozzle inlet and provides the constriction to increase velocity of fluid flow.

Fluid conduits having a flow path defined by smooth continuous nozzle walls and an absence of internal obstructions provide laminar flow of the fluid flowing through them. Laminar fluid flow is desirable over turbulent fluid flow because it optimizes fluid flow through the nozzle and provides a uniform spray from the exit opening. A disadvantage with some nozzle designs is that obstructions, sharp corners, and abrupt changes in fluid flow direction in the fluid flow path of a nozzle present obstructions in the flow of fluid through the nozzle that cause turbulence in the flow of fluid through the nozzle. Turbulence in fluid flow through nozzles is undesirable in applications in which a spray from the exit opening that is uniform across the width of the exit opening is desired.

There also is a need for a nozzle that can modulate the flow of fluid exiting the nozzle at a given pressure to vary a spray pattern of fluid exiting the nozzle to customize the spray pattern for a particular situation. Such adjustability is particularly suitable for applications, such as firefighting, that present varied needs for liquid spray patterns.

Accordingly, there is a need for a nozzle that adjusts the effective cross-sectional area of the exit opening to vary the shape of the fluid stream from the exit opening but that does not present inclusions, obstructions, or sharp corners in the fluid flow path through the nozzle that create turbulence in the fluid. There is also a need for a compact nozzle that is rugged and yet provides optimal laminar fluid flow.

### SUMMARY

The present disclosure describes embodiments of a nozzle and the method of its operation that optimizes fluid flow through the nozzle and consequently the throw distance and coverage of the fluid stream exiting the nozzle. The nozzle includes a nozzle outlet in the form of a variable outlet opening in which the effective width of the opening can be varied manually by an operator to shape a spray pattern of fluid exiting the nozzle.

In an exemplary embodiment, an adjustable nozzle includes a nozzle body having an inlet section with an inlet opening, an outlet section with an outlet opening, and a fluid flow path extending from the inlet opening to the outlet opening; an adjustable spray restrictor segment located in the outlet section; and an actuator that displaces the adjustable spray restrictor segment toward and away from a center of the fluid flow path, thereby varying an effective width of the outlet opening to vary a pattern of fluid flowing from the fluid flow path through the outlet opening.

In another embodiment, a method of varying a width of an oblong stream of fluid exiting an oblong outlet opening in an outlet section of a nozzle body includes actuating an adjustment collar of an actuator to displace an adjustable spray restrictor segment toward and away from a center of a fluid flow path through the nozzle body, thereby varying an effective width of the oblong outlet opening to vary a pattern of fluid flowing from the fluid flow path through the outlet opening.

Other objects and advantages of the disclosed nozzle with adjustable spray will be apparent from the following description, the accompanying drawings, and the appended claims.

### BRIEF DESCRIPTION OF THE DRAWINGS

FIG. 1 is a perspective view of an exemplary embodiment of the disclosed smooth bore nozzle;

FIG. 2 is an exploded perspective view of the smooth bore nozzle of FIG. 1;

FIG. 3 is a top view in section of the smooth bore nozzle of FIG. 1 showing the fluid flow path, in which the pivot arms are actuated to provide a wide exit stream;

FIG. 4 is a top view in section of the smooth bore nozzle of FIG. 1 showing the fluid flow path, in which the pivot arms are actuated to provide a narrow exit stream;

FIG. 5 is a perspective view of the smooth bore nozzle of FIG. 1 in which the adjustment collar is removed;

FIG. 6 is a side elevation in section of the smooth bore nozzle of FIG. 1 showing the fluid flow path;

FIG. 7 is a perspective view of the interior of a first adjustment collar element of the embodiment of FIG. 1;

FIG. 8 is a perspective view of the interior of a second adjustment collar element of the embodiment of FIG. 1;

FIG. 9 is a perspective view of an embodiment of a pivot arm of the embodiment of FIG. 1;

FIG. 10 is a perspective view of another embodiment of a pivot arm of the embodiment of FIG. 1; and

FIG. 11 is a schematic diagram of an embodiment of the disclosed smooth bore nozzle.

### DETAILED DESCRIPTION

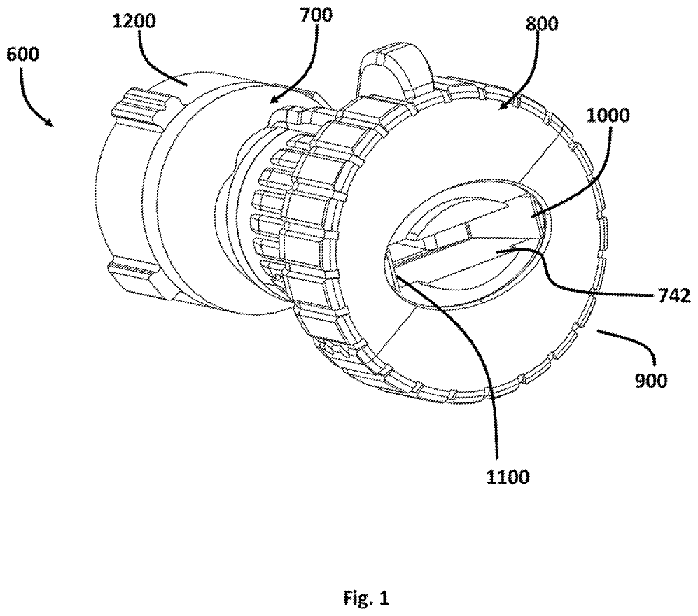

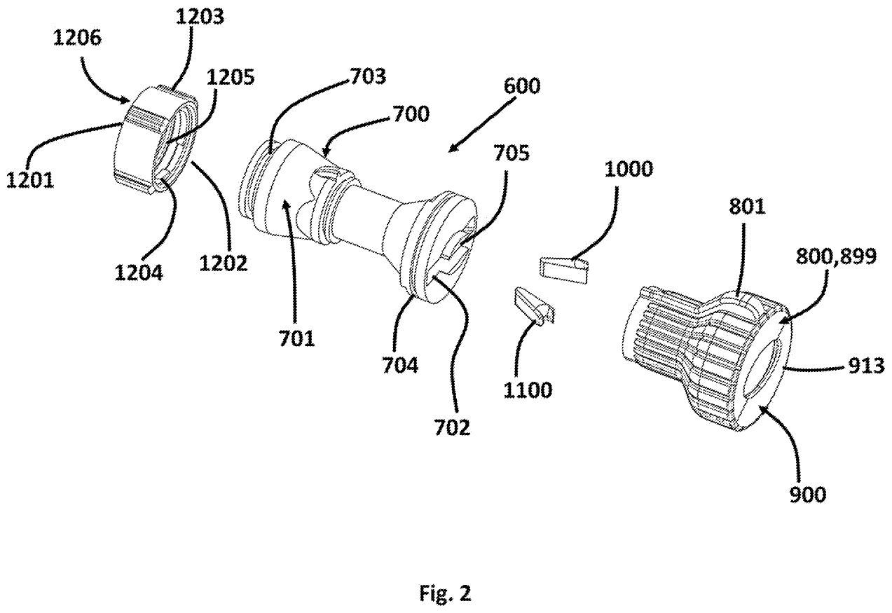

As shown in FIGS. 1, 2, 3, and 6, in an exemplary embodiment, the smooth bore nozzle assembly, generally designated 600, includes a nozzle body, generally designated 700, having an inlet section 701 with first and a second smooth, planar opposing converging inlet side walls 713, 714, contiguous with smooth, planar opposing converging inlet top and bottom walls 715, 716 that define an inlet section flow path T2. The first and the second inlet side walls 713, 714 and the inlet top and bottom walls 715, 716 form an inlet section opening 717, an inlet section outlet opening 718, and an unobstructed rectangular inlet section 701 from the inlet section opening to the inlet section outlet opening.

In an embodiment, the nozzle body 700 includes a transition section 501 upstream of the inlet section T2. The transition section 501 transitions from a round cross section to the rectangular cross section of the inlet section 701. In an embodiment, the nozzle body 700 includes a fitting 1205 that takes the form of a threaded swivel adaptor 1200 that attaches the nozzle assembly 600 to a source of fluid under pressure, such as a hose, and in embodiments, a firehose. The fitting 1205 is secured to the nozzle body 700 by a retaining ring 1204 that is seated in an annular recess 703, which permits relative rotation of the fitting and the nozzle body 700. In an embodiment, the transition section T1 and the inlet section T2 are unitary.

The nozzle body 700 includes a straight section 502 having first and second smooth, planar opposing parallel side walls 719, 720 contiguous with the first and the second inlet side walls 713, 714, respectively, and contiguous with smooth, planar opposing parallel top and bottom walls 722, 724, respectively, that are contiguous with the inlet top and bottom walls 715, 716. The first and second parallel side walls 719, 720 and opposing parallel top and bottom walls 722, 724, define a straight section flow path T3. The first and second parallel side walls 719, 720 and the first and the second inlet side walls 713, 714 are contiguous with the inlet top and bottom walls 715, 716, respectively. The first and the second opposing parallel side walls 719, 720 and the opposing parallel top and bottom walls 722, 724 form a straight section inlet opening 726 attached to receive the fluid from the inlet section outlet opening 718 and a straight section outlet opening 728. The straight section inlet opening 726 and straight section outlet opening 728 together form the unobstructed rectangular straight section 502. The fluid passageway T3 of straight section 502 is a fluid passageway from the straight section inlet opening 726 to the straight section outlet opening 728 and functions as a fluid relaxation section of the nozzle body 700.

In embodiments, the nozzle body 700 includes an outlet section 730 having smooth, planar opposing converging outlet top and bottom walls 732, 734, respectively, contiguous with the parallel top and bottom walls 722, 724, respectively, and contiguous with first and second opposing diverging outlet side walls 736, 738, respectively, that are contiguous with the opposing parallel side walls 719, 720, forming an outlet flow passageway T4. The outlet top and bottom walls 732, 734 are contiguous with the first and the second outlet side walls 736, 738, respectively, to form an outlet section inlet opening 740 attached to receive the fluid from the straight section outlet opening 728. The outlet section 730 forms an unobstructed rectangular outlet section 730 from the outlet section inlet opening 740 to terminate in an oblong, fixed outlet opening 742.

In an exemplary embodiment, the inlet section 701, rectangular straight section 502, and outlet section 730 together form a continuous, linear, unobstructed fluid flow path D. In an embodiment, a cross-sectional areas of the rectangular inlet section 701 and the rectangular outlet section 730 (as well as rectangular straight section 502) remain constant or decrease in a downstream direction of the fluid flow path D (i.e., the direction of arrow D), and a perimeter of a cross section of the rectangular inlet section 701 decreases along a length of the inlet section and a perimeter of a cross section of the rectangular outlet section 730 increases along a length of the outlet section.

In an embodiment in which the fluid flowing through the nozzle assembly 600 is water, as water flows from inlet section 701 to straight section 502 and from the straight section to the outlet section 730, in some nozzle geometries having converging inlet sections and diverging outlet sections the direction of the fluid flow D can change sharply. At such sharp transitions, turbulence is generated, causing fluid to move spirally. The areas of spirally moving fluid are also known as eddies. These local eddies can persist downstream causing loss in water kinetic energy in the direction of fluid flow. This loss due to this sharp transition can be described by bend loss B that is given by the following equation:

B=(KV²)/2g (1)

where K is dependent on the total length of the bend and the ratio of the curvature of the bend and the cross-section height. For a circular pipe the cross-section height is equivalent to the pipe diameter and for a square pipe the value is equivalent to the side of the square. Vis the average velocity of fluid flowing through the nozzle assembly 600. However, by creating a transitional region (straight section 502) between the converging section (inlet section 701) and diverging section (outlet section 730) in the nozzle body 700 the impact of change in fluid direction is reduced. This transitional region is achieved by providing the straight section 502. Straight section 502 minimizes the swirling motion of the local eddies to propagate in the fluid flow through the nozzle 600.

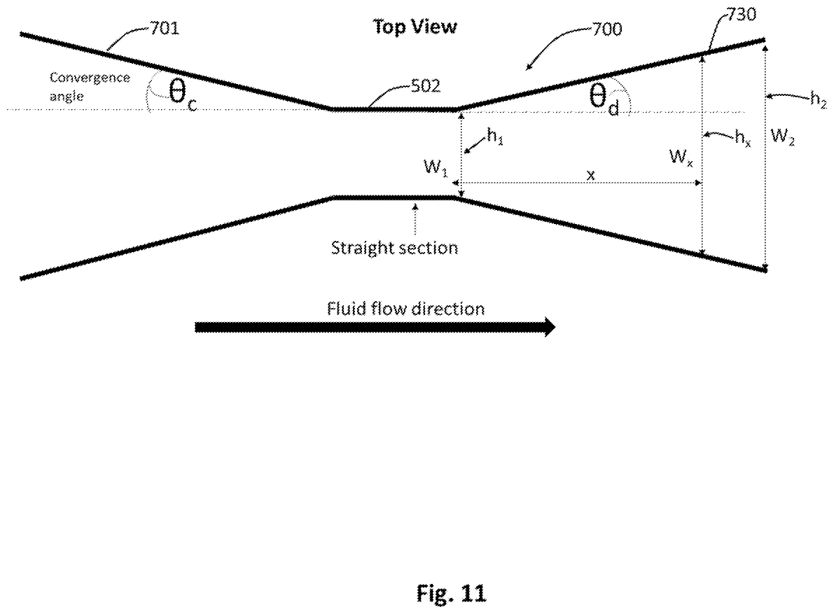

As shown in FIG. 11, to be effective in reducing eddies in the fluid flow path D, the length of the straight section 502 depends on the cross-section height hₜ and the convergence and divergence angles of the fluid flow path D. For convergence and divergence angles θ_{c}, θ_{d}, respectively, of less than 15° with the center C of the linear fluid flow path D, the straight section is at least 2 times the cross-section height hₜ at the transition region. For convergence and divergence angles θ_{c}, θ_{d}, respectively, of between 15° and 30° with the center C of the linear fluid flow path D, the straight section is at least 4 times the cross-section height hₜ at the transition region. For divergence angle θ_{d} of greater than 30°, a two-step transition to mitigate local eddies associated with sudden change in fluid direction is necessary. The second transition step is dictated by a transitional divergence angle.

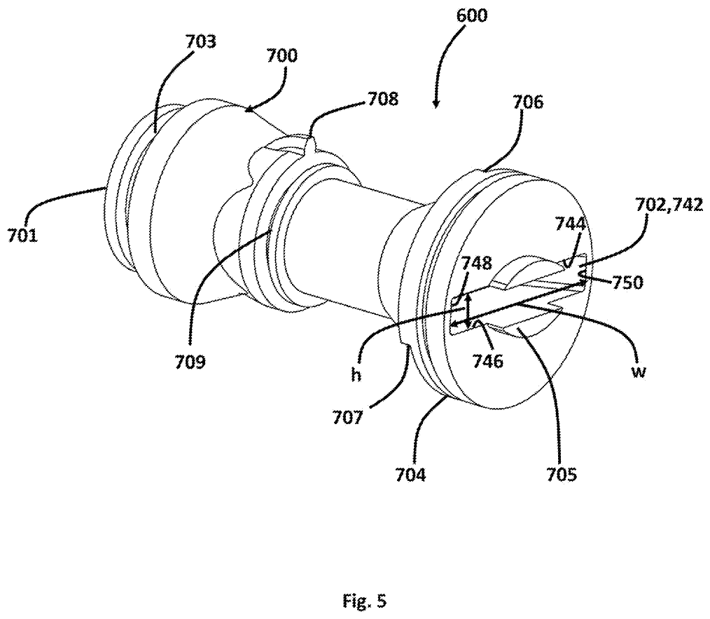

As the fluid goes from inlet section 701 (converging) to straight section 502 (straight section) and finally to outlet section 730 (diverging section), the cross-sectional area is either kept constant or reduced in the downstream direction of fluid flow path D to allow maximizing fluid velocity at the exit. In the outlet section 730, (the diverging section) the width dimension W of the fluid flow path D (see FIG. 5) increases continuously. If the width of cross-section in the straight section is W₁, width of the cross-section at the nozzle exit is W₂ and the width anywhere in between is Wₓ where x denotes the distance from the end of the straight section, then, as shown in FIG. 11:

Wₓ=W₁+(2×tan θ_{d}) (2)

where θ_{d} is the divergence angle with respect to the straight section.

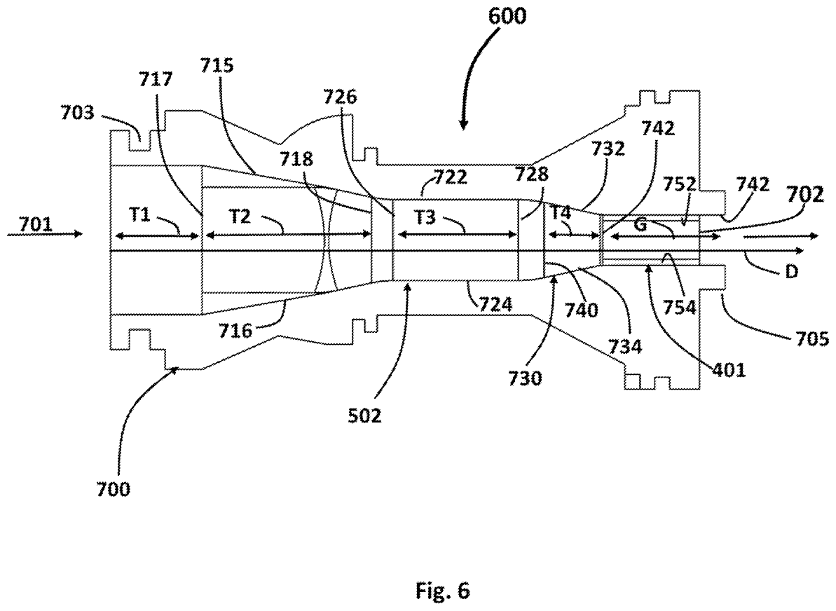

As the width W diverges, the height h (FIG. 6) needs to converge or reduce to maintain or reduce the cross-sectional area (W×h). If the height h at the end of the straight section 502 is h₁ and height at the end of the diverging section is h₂, and the height at distance x from the end of the straight section is hₓ, then:

W₁h₁≥Wₓhₓ≥W₂h₂ (3)

W₁h₁≥Wₓhₓ (4)

W₁h₁≥(W₁+(2×tan θ_{d}))hₓ (5)

hₓ=K[(W₁h₁)/(w₁+2×tan θ_{d})] (6)

where K≤1 and depends on the ratio of cross-sectional area at the straight section and end of the diverging section.

In an embodiment, a rate of convergence (i.e., slope or angle made with the center of fluid flow path D) of the opposing converging first and second inlet side walls 713, 714 and/or the converging inlet top and bottom walls 715, 716 is greater than a rate of divergence (i.e., slope or angle made with centerline D) of the first and the second opposing diverging outlet side walls 736, 738, such that a velocity of a fluid flowing through the nozzle assembly 600 increases.

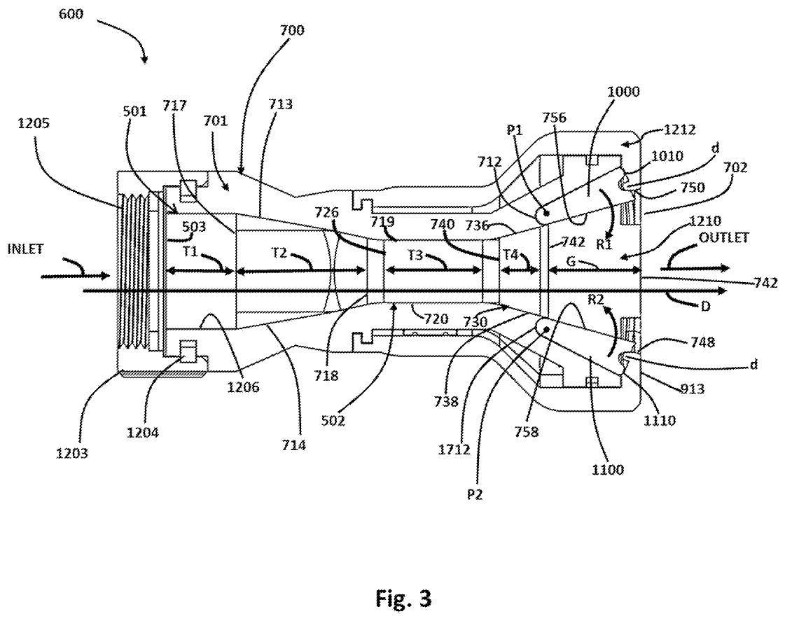

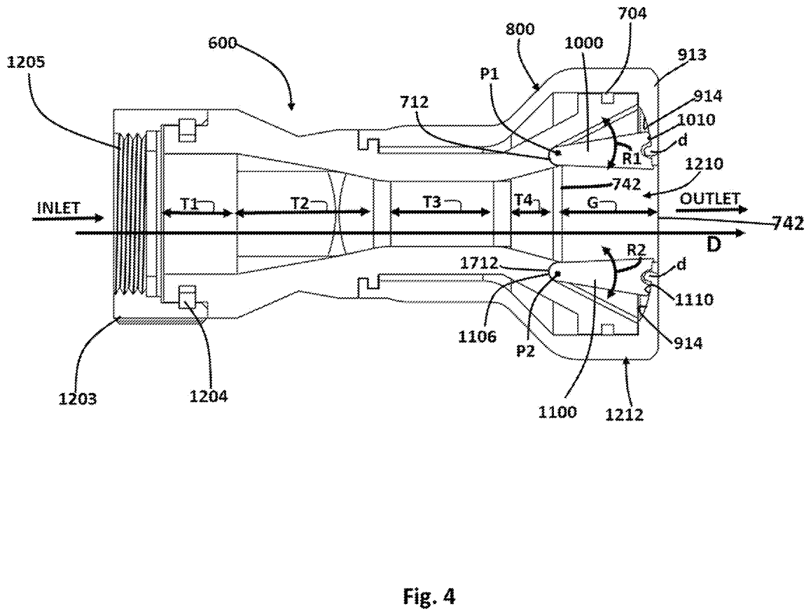

In an embodiment, the outlet section 730 terminates in a modulation segment 401 that defines a modulation flow passageway G (see, e.g., FIGS. 3 and 4). The modulation segment 401 terminates in a nozzle outlet opening 702. The nozzle outlet opening 702 is defined by parallel opposing top and bottom outlet edges 744, 746, respectively, rectilinear along entire lengths thereof, and first and second opposing side edges 748, 750, respectively, wherein the opposing top and bottom outlet edges are parallel and contiguous with flat, parallel outlet top and bottom walls 752, 754, respectively, of the modulation segment 401. In an embodiment, the modulation segment 401 includes first and second opposing side edges 756, 758 that diverge and are a linear continuation of side walls 736, 738 of outlet section 730.

In an embodiment, the side edges 756, 758 and side walls 736, 738 are continuous, smooth, and the fluid pathway is unobstructed along its length. Similarly, the walls of the transition section 501 and the inlet section 701 are continuous, smooth, and provide an unobstructed fluid pathway. Accordingly, in an embodiment, the inlet opening 717 of the inlet section 701 is rectangular and a periphery of the inlet opening of the inlet section is contiguous with a periphery of the rectangular outlet of the transition section 501.

In an embodiment, the outlet section 730 and modulation segment 401, which define the modulation flow passageway G, provide a smooth fluid pathway to the nozzle outlet 702. This is accomplished by the modulation segment 401 having first and second opposing diverging side walls 756, 758 contiguous with the first and the second opposing diverging outlet section side walls 736, 738, and parallel top and bottom walls 752, 754 contiguous with the converging outlet top and bottom walls 732, 734. The first and the second side walls 756, 758 are contiguous with the first and the second opposing extension side walls 736, 738 and terminate in the unobstructed rectangular modulation section 401 from the outlet extension section inlet opening 740 to receive the fluid from the straight section outlet opening 728 and terminating in the oblong nozzle outlet opening 702. In embodiments, the shape of the cross section of the oblong nozzle outlet opening 702 is selected from a rectangle, rhombus, and an ellipse.

In embodiments, a divergence angle of up to 30° made by the diverging first and the second opposing extension side walls 736, 738 (and extending to side walls 756, 758) with the opposing parallel side walls 719, 720, a length of the straight section T3 is at least 2 times a height h of the cross section of the straight section outlet opening 728. In embodiments, a height hₓ between the outlet top and bottom walls at a distance x from the outlet section inlet opening is determined by equation (6).

In an embodiment, the diverging first and the second opposing extension side walls 736, 738 each have a first segment that diverges from a centerline of the outlet section, represented by linear flow pathway D, at a first angle and a second segment, downstream of the first segment, that diverges from a centerline of the outlet section fluid passageway at a second angle that is greater than the first angle. In an embodiment, the second segment takes the form of walls 756, 758 of modulation segment 401. In an embodiment, the second segment is adjacent and is contiguous with the first segment. In an embodiment, the first segment and the second segment of the diverging first and the second opposing extension side walls 736, 738 are each smooth and planar in shape. In an embodiment, the second segments are contiguous with the first segments and make an angle with the first segments that does not exceed 30°.

In one exemplary embodiment, a nozzle 600 includes an inlet section 701 having a first and a second smooth, planar opposing inlet side walls 713, 714 and smooth, planar opposing inlet top and bottom walls 715, 716. The first and the second inlet side walls 713, 714 and the inlet top and bottom walls 715, 716 are contiguous and form an inlet opening 717, an inlet section outlet opening 718, and an unobstructed rectangular inlet section fluid passageway T2 from the inlet section inlet opening to the inlet section outlet opening. At least one pair of the first and second opposing inlet side walls 713, 714 and the inlet top and bottom walls 715, 716 are converging such that a cross sectional area of the inlet section fluid passageway decreases continuously from the inlet section inlet opening to the outlet section outlet opening.

The inlet section 701 is contiguous with a straight section 502 having first and second smooth, planar opposing parallel side walls 719, 720 contiguous with the first and the second inlet side walls 713, 714, respectively, and having smooth, planar opposing parallel top and bottom walls 722, 724 that are contiguous with the inlet top and bottom walls 715, 716. The first and the second opposing parallel side walls 722, 724 and the opposing parallel top and bottom walls 719, 720 form a straight section inlet opening 726 attached to receive the fluid from the inlet section outlet opening 718, a straight section outlet opening 728, and an unobstructed rectangular straight section fluid passageway T3 from the straight section inlet opening to the straight section outlet opening.

The outlet section 730 includes smooth, planar opposing converging outlet top and bottom walls 732, 734 contiguous with the parallel top and bottom walls 722, 724, respectively, and is contiguous with first and second opposing diverging outlet side walls 736, 738 that are contiguous with the opposing parallel side walls 719,720. The outlet top and bottom walls 732, 734 are contiguous with the first and the second outlet side walls 736, 738 to form an outlet section inlet opening 740 attached to receive the fluid from the straight section outlet opening 728 and form an unobstructed rectangular outlet section fluid passageway T4 from the outlet section inlet opening to terminate in an oblong outlet opening 742. At least one pair of the first and second opposing outlet side walls 736, 738 and the outlet top and bottom walls 732,734 are diverging such that a cross sectional area of the outlet section fluid passageway T4 decreases continuously from the outlet section inlet opening 740 to the oblong outlet opening 742.

As the cross-sectional area of the rectangular inlet fluid passageway T2 and a cross-sectional area of the rectangular outlet section fluid passageway T4 decrease in a downstream direction, a perimeter of a cross section of the rectangular inlet section decreases along a length of the inlet section 701 and a perimeter of a cross section of the rectangular outlet section fluid passageway T4 increases along a length of the outlet section 730. The rectangular inlet fluid passageway T2, the straight section fluid passageway T3, and the outlet section fluid passageway T4 together define a continuous nozzle fluid passageway D bilaterally symmetrical about a central axis of the nozzle 600 extending in a fluid flow direction.

In an embodiment, the inlet section 701 includes a transition section 501 having a round inlet 503, a rectangular outlet that coincides with inlet opening 717 of the inlet section 701, and a continuous side wall 1206 that extends between the round inlet and the rectangular outlet and defines a fluid pathway T1 attached to the inlet opening of the inlet section. The side wall 1206 is defined by an entrance wall segment circular in cross section that transitions to an exit wall segment that is rectangular in cross section. In an embodiment, the transition section 501 is unitary and contiguous with the inlet section 701.

In an embodiment, a method of making a nozzle 600 includes forming an inlet section 701 having a first and a second smooth, planar opposing converging inlet side walls 713, 714 and smooth, planar opposing converging inlet top and bottom walls 715, 716 and attaching the first and the second inlet side walls to the inlet top and bottom walls to form an inlet opening 717, an inlet section outlet opening 718, and an unobstructed rectangular inlet section fluid passageway T2 from the inlet opening to the inlet section outlet opening. A straight section 502 is formed having first and second smooth, planar opposing parallel side walls 719, 720 and smooth, planar opposing parallel top and bottom walls 722, 724 such that the first and the second parallel side walls are attached to the parallel top and bottom walls to form a straight section inlet opening 726, a straight section outlet opening 728, and an unobstructed rectangular straight section fluid passageway T3 from the straight section inlet opening to the straight section outlet opening.

The first and the second parallel side walls 719, 720 are attached to the first and the second inlet side walls, 713, 714, respectively, and the parallel top and bottom walls 722, 724 are attached to the converging inlet top and bottom walls to receive the fluid from the inlet section outlet opening 718. An outlet section 730 is formed having smooth, planar opposing converging outlet top and bottom walls 732, 734 and first and second smooth, planar opposing diverging outlet side walls 736, 738 that are contiguous with the opposing converging outlet top and bottom walls to form an outlet section inlet opening 740 attached to receive the fluid from the straight section outlet opening 718 and an outlet opening 742. The top and bottom walls 732, 734 and side walls 736, 738 form an unobstructed rectangular outlet section fluid passageway T4 from the outlet section inlet opening 740 to terminate in an oblong outlet opening.

The outlet top and bottom walls 732, 734 are attached to the parallel top and bottom walls 722, 724, and the first and second opposing diverging outlet side walls 736, 738 are attached to the first and the second parallel side walls 719, 720. A cross-sectional area of the rectangular inlet section fluid passageway T2 and a cross-sectional area of the rectangular outlet section fluid passageway T4 decrease in a downstream direction, and a perimeter of a cross section of the rectangular inlet section decreases along a length of the inlet section and a perimeter of a cross section of the rectangular outlet section fluid passageway increases along a length of the outlet section. The rectangular inlet fluid passageway T2, the straight section fluid passageway T3, and the outlet section fluid passageway T4 together define a continuous nozzle fluid passageway D bilaterally symmetrical about a central axis of the nozzle extending in a fluid flow direction.

In an exemplary embodiment (see FIGS. 1-8), the nozzle 600 takes the form of an adjustable nozzle. In the embodiment shown in the figures, the adjustable nozzle 600 is configured to vary a width of the fluid stream exiting the nozzle outlet 702 within a predetermined range. The adjustable nozzle 600 includes a nozzle body 700 having an inlet section 701 with an inlet section opening 717, an outlet section 730 in which the nozzle outlet 702 of the modulation segment 401 takes the form of a variable outlet opening 742, and the fluid flow path D extends from the inlet opening to the outlet opening. The modulation segment 401 takes the form of an adjustable spray restrictor segment 1210 in the outlet section 730.

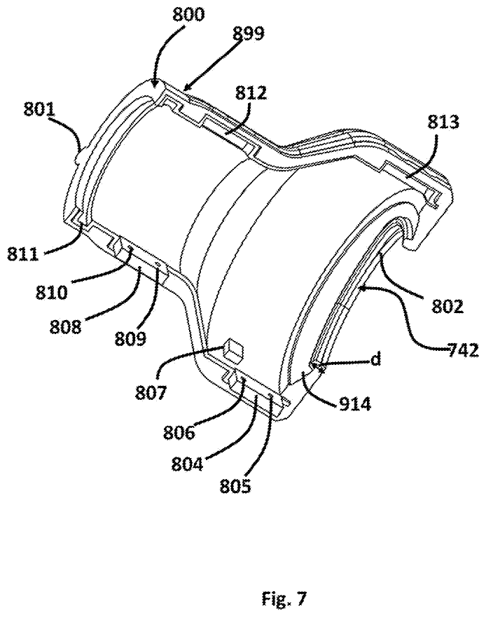

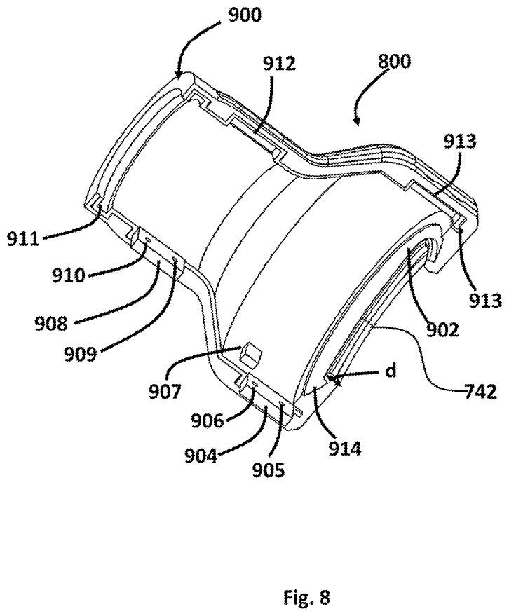

The nozzle 600 includes an actuator 1212 that displaces the adjustable spray restrictor segment 1210 toward and away from a center of the fluid flow path D, thereby varying an effective width W (see FIG. 5) of the variable outlet opening 742 to vary a pattern of fluid flowing from the fluid flow path D through the variable outlet opening 742. In an embodiment, the actuator 1212 includes a manually positionable adjustment collar 800 (see FIGS. 7 and 8), which in embodiments is in the form of two complementary halves 899, 900, that is rotatably mounted on the nozzle body 700. Manual rotation of the adjustment collar 800 relative to the nozzle body 700 displaces the adjustable spray restrictor segment 1210.

Optionally, the adjustment collar 800 includes an indicator tab 801 that corresponds to a position of the spray restrictor segment 1210 and mating tabs 808, 908 and grooves 812, 912 that effect proper mating of the halves 899, 900. In an embodiment, the adjustment collar 800 includes a second set of mating tabs 804, 904 and grooves 813, 913 that facilitate proper mating of the halves 899, 900 during assembly. Optionally, the tabs include screw holes 810, 910, 809, 909, 806, 906, 805, 905 to receive screws (not shown) to secure the halves 899, 900 together.

As shown in FIGS. 3, 4, and 9, in an embodiment, the adjustable spray restrictor segment 1210 includes at least a first spray adjustment arm 1000 that is displaced by rotation of the adjustment collar 800 toward and away from the center of the fluid flow path D to vary the effective width W of the variable outlet opening 742. In an embodiment, the first spray adjustment arm 1000 makes a pivotal engagement with the outlet section 730 and includes a downstream bearing surface 1010 that engages the adjustment collar 800.

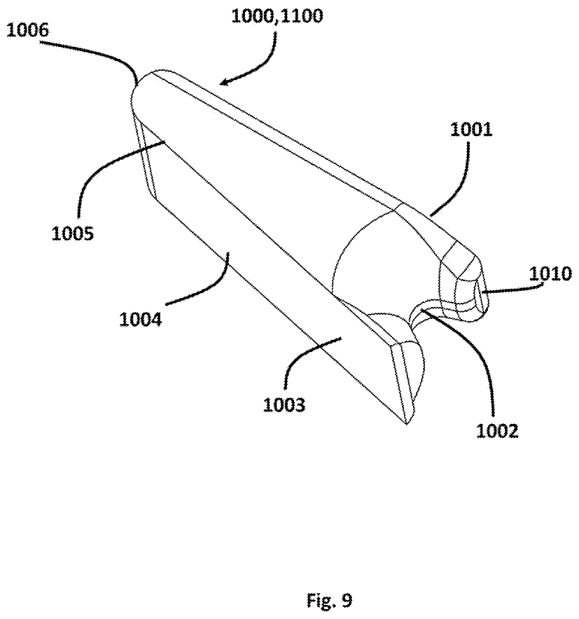

In an embodiment, the nozzle body 700 includes a first bearing recess 712 in the outlet section 730 (see FIGS. 3 and 4). The first spray adjustment arm 1000 includes an upstream bearing surface 1006 (see FIG. 9) that engages the first bearing recess 712 to make the pivotal engagement about a first pivot point P1. In an embodiment, the adjustment collar 800 includes an upstream end face 913 having an internal or upstream eccentric groove 914 extending about the variable outlet opening 742 that receives and engages the downstream bearing surface 1010, such that rotation of the adjustment collar pivots the first spray adjustment arm toward and away from the center of the fluid flow path D (see FIGS. 3 and 4). The radially inner boundary of the eccentric groove 914 is bounded and defined at an outer perimeter by an eccentric ridge d.

In an embodiment, the eccentric groove 914 is shaped to pivot the first spray adjustment arm 1000 between a first position, shown in FIG. 4, resulting in a minimum spray width W and a second position, shown in FIG. 3, resulting in a maximum spray width. In an embodiment, the eccentric groove 914 is in the form of a camming surface that engages the downstream bearing surface 1010 of the first spray adjustment arm 1000, and the camming surface is curved, having a radius of curvature that corresponds to a radius of the first spray adjustment arm from the first pivot point P1 to the camming surface of the eccentric groove 914. In embodiments, the eccentric groove 914 is formed of groove segments 802, 902 on the complementary halves 899, 900.

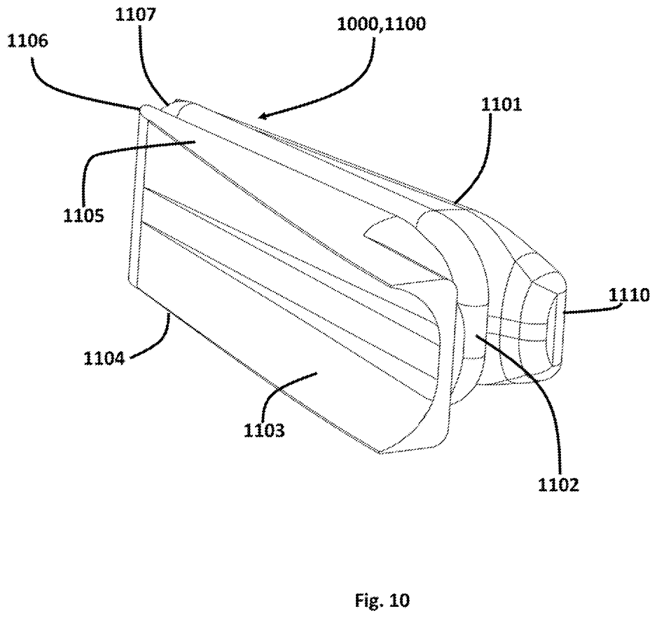

In an embodiment, the adjustable spray restrictor segment 1210 includes a second spray adjustment arm 1100 that is opposed to the first spray adjustment arm 1000. The second spray adjustment arm 1100 is also displaced by rotation of the adjustment collar 800 toward and away from the center of the fluid flow path D to vary the effective width W of the variable outlet opening 742. The nozzle body 700 includes a second bearing recess 1712 in the outlet section. As shown in FIG. 10, the second spray adjustment arm 1100 includes an upstream bearing surface 1106 that engages the second bearing recess 1712 to make a pivotal engagement with the outlet section about a second pivot point P2 and a downstream bearing surface 1110 that engages the camming surface of the eccentric groove 914 of the adjustment collar 800.

In an embodiment, the outlet section 703 of the adjustable nozzle 600 includes the modulating segment 401 in the form of a terminal segment having opposed planar, parallel top and bottom walls 752, 754 and first and second opposed planar side walls 756, 758 contiguous with the top and bottom walls. The first and second spray adjustment arms 1000, 1100 are mounted in the terminal segment to pivot toward and away from the first and second side walls 756, 758, respectively, when displaced by rotation of the adjustment collar 800.

In an embodiment, the adjustment collar 800 is connected to the first and second spray adjustment arms 1000, 1100 to pivot the first and second spray adjustment arms relative to the terminal segment of the modulating segment 401 toward and away from the first and second opposed planar side walls 756, 758 to selectively vary the effective width W of the variable outlet opening 742. In an embodiment, the first and second spray adjustment arms 1000, 1100 are pivotally mounted at the upstream ends 1006, 1106, respectively, thereof to the first and second bearing recesses 712, 1712, respectively, of the first and second side walls 756, 758.

In one embodiment shown in FIG. 9, the first and second spray adjustment arms 1000, 1100 (only one first spray adjustment arm 1000 is shown, it being understood that for this embodiment spray adjustment arm 1100 is identical thereto) include a guide surface 1003 that faces the center C (FIG. 11) of the fluid flow path D. The upstream bearing surface 1006, which is curved to match the curvature of the first bearing recess 712, is connected to the downstream bearing surface 1010 by a spine 1001 that is opposite the guide surface 1003.

In another embodiment shown in FIG. 10, the first and second spray adjustment arms 1000, 1100 (only one second spray adjustment arm 1100 is shown, it being understood that first spray adjustment arm 1000 is identical thereto) include a guide surface 1103 that faces the center C of the fluid flow path D. The upstream bearing surface 1106, which is curved to match the curvature of the second bearing recess 1712, is connected to the downstream bearing surface 1110 by a spine 1101. The guide surfaces 1003, 1103 are positioned in the terminal segment of the modulation section 730 to contact fluid flowing through the terminal segment of the modulating segment 401 and define the effective width W of the variable outlet opening 728.

In the embodiment of FIG. 9, the guide surfaces 1003 of the first and second adjustment arms 1000, 1100 are substantially flat and planar. In the embodiment of FIG. 10, the guide surfaces 1103 of the first and second adjustment arms 1000, 1100 are curved in a width direction (i.e., the “h” dimension in FIG. 5). As shown in the embodiment of FIG. 10, the guide surfaces 1103 of the first and second adjustment arms 1000, 1100 are shaped to transition in a downstream direction from a flat contour to a curved contour in a width direction. In an embodiment, the adjustment arms 1000, 1100 include flat upper and lower surfaces 1004, 1005 and 1104, 1105, respectively, that bear against, but pivot relative to, the top and bottom walls 752, 754 of the modulation segment 401 to provide a fluid seal.

Also, in the embodiment shown in FIG. 10, the first and second adjustment arms 1000, 1100 (only second adjustment arm 1100 is shown in FIG. 10, it being understood that adjustment arm 1000 is identical thereto in this embodiment) optionally include a gasket 1107 that extends about the adjustment arm in an annular, longitudinal recess between the spine 1101 and the face 1103. This gasket prevents fluid leakage between the face 1103 and the top and bottom walls 752, 754 of the modulation segment 401. In embodiments, the gasket 1107 is made of rubber or an elastomer.

In both the embodiments shown in FIGS. 9 and 10, the first and second adjustment arms 1000, 1100 include notches or cutouts 1002, 1102 that engage and are captured by the eccentric ridge d formed about the variable outlet opening 742. As the adjustment collar 800 is rotated relative to the nozzle body 600, the first and second adjustment arms 1000, 1100, which pivot in response to the varying distance of the eccentric ridge d from the center of the fluid flow path D, vary the effective width W of the variable outlet opening 742. In embodiments, the eccentric ridge d is in the form of an ellipse, but also can be in the form of other eccentric (i.e., non-circular) shapes to provide different responses in width of the spray pattern exiting the variable outlet opening 742 corresponding to a given rotation of the adjustment collar 800.

As shown in FIGS. 7 and 8, in an embodiment the adjustment collar 800 includes stops or bosses 807, 907 positioned to engage cutouts 706, 707 formed in the outer periphery of the nozzle body 700. The stops 807, 907 limit rotation of the adjustment collar 800 relative to the nozzle body 700 to a preselected amount. In an embodiment, the relative rotation is limited to a 90° clockwise and counterclockwise rotation. The eccentric groove 914 is sized and shaped such that such a 90° relative rotation of the adjustment collar 800 will cause the first and second adjustment arms 1000, 1100 to pivot from their maximum separation shown in FIG. 3, and hence maximum effective width W of the variable outlet opening 742 and fluid stream exiting the variable outlet opening, to their minimum separation shown in FIG. 4, and hence minimum effective width W of the variable outlet opening and exiting fluid stream.

Accordingly, the first and the second spray adjustment arms 1000, 1100 engage the eccentric groove 914 and eccentric ridge d formed in the actuator 1212 such that the rotation of the actuator causes the eccentric groove to move relative to the first and second spray adjustment arms, thereby pivoting the first and second spray adjustment arms toward and away from the first and second side walls 756, 758, respectively. In an embodiment, the bottom surface of the eccentric groove 914 is parabolic in contour such that the downstream bearing surfaces 1006, 1010 maintain constant contact with the bottom surface of the groove during their pivotal movement from maximum separation to minimum separation.

In an embodiment, a method of varying a width of an oblong stream of fluid exiting a variable outlet opening 742 in an outlet section 730 of a nozzle body 700 of a nozzle 600 (indicated by arrow D) includes actuating an adjustment collar 800 of an actuator to displace a spray modulating segment 1000, 1100 toward and away from a center of a fluid flow path D through the nozzle body, thereby varying an effective width of the oblong outlet opening 742 to vary a pattern of fluid flowing from the fluid flow path through the outlet opening 742. In an embodiment, actuating the adjustment collar 800 includes pivoting first and second opposed spray adjustment arms 1000, 1100 attached to the outlet section 730 and extending into the fluid flow path D toward and away from the center of the fluid flow path, thereby varying the effective width of the variable outlet opening 742 to vary the width of the rectangular stream of fluid from the variable outlet opening.

The disclosed smooth bore nozzle 600 provides an economical design for a fluid nozzle that finds a particularly useful application as a firefighting nozzle because it is robust and provides minimal internal resistance to provide maximum stream distance for fluid under a given pressure and volume flow rate. While the forms of apparatus and methods disclosed herein are preferred embodiments of the disclosed smooth bore nozzle, it is understood that the invention is not limited to these precise embodiments and that changes may be made therein without departing from the scope of the invention.

What is claimed is:

1. An adjustable nozzle, comprising:
a nozzle body having an inlet section with an inlet opening, an outlet section with an outlet opening, and a fluid flow path extending from the inlet opening to the outlet opening;
an adjustable spray restrictor segment located in the outlet section; and
an actuator that displaces the adjustable spray restrictor segment toward and away from a center of the fluid flow path, thereby varying an effective width of the outlet opening to vary a pattern of fluid flowing from the fluid flow path through the outlet opening.

2. The adjustable nozzle of claim 1, wherein the actuator includes an adjustment collar rotatably mounted on the nozzle body, wherein rotation of the adjustment collar relative to the nozzle body displaces the adjustable spray restrictor segment.

3. The adjustable nozzle of claim 2, wherein the adjustable spray restrictor segment includes at least a first spray adjustment arm that is displaced by rotation of the adjustment collar toward and away from the center of the fluid flow path to vary the width of the outlet opening.

4. The adjustable nozzle of claim 3, wherein the first spray adjustment arm makes a pivotal engagement with the outlet section and includes a downstream bearing surface that engages the adjustment collar.

5. The adjustable nozzle of claim 3, wherein the nozzle body includes a first bearing recess in the outlet section; and the first spray adjustment arm includes an upstream bearing surface that engages the bearing recess to make the pivotal engagement about a first pivot point.

6. The adjustable nozzle of claim 5, wherein the adjustment collar includes an end face having an internal eccentric groove extending about the outlet opening that receives the downstream bearing surface, such that rotation of the adjustment collar pivots the first spray adjustment arm toward and away from the center of the fluid flow path.

7. The adjustable nozzle of claim 6, wherein the eccentric groove is shaped to pivot the first spray adjustment arm between a first position resulting in a minimum spray width and a second position resulting in a maximum spray width.

8. The adjustable nozzle of claim 6, wherein the eccentric groove includes a camming surface that engages the downstream bearing surface of the first spray adjustment arm, and the camming surface is curved, having a radius of curvature that corresponds to a radius of the first spray adjustment arm from the first pivot point to the camming surface.

9. The adjustable nozzle of claim 8, wherein the adjustable spray restrictor segment includes a second spray adjustment arm that is opposed to the first spray adjustment arm; and the second spray adjustment arm is displaced by rotation of the adjustment collar toward and away from the center of the fluid flow path to vary the effective width of the outlet opening.

10. The adjustable nozzle of claim 9, wherein the nozzle body includes a second bearing recess in the outlet section; and the second spray adjustment arm includes an upstream bearing surface that engages the second bearing recess to make a pivotal engagement with the outlet section about a second pivot point and a downstream bearing surface that engages the eccentric groove and the camming surface of the adjustment collar.

11. The adjustable nozzle of claim 10, wherein the outlet section includes a terminal segment having opposed planar, parallel top and bottom walls and first and second opposed planar side walls contiguous with the top and bottom walls; and wherein the first and second spray adjustment arms are mounted in the terminal segment to pivot toward and away from the first and second side walls, respectively, when displaced by the adjustment collar.

12. The adjustable nozzle of claim 11, wherein the adjustment collar is connected to the first and second spray adjustment arms to pivot the first and second spray adjustment arms relative to the terminal segment toward and away from the first and second opposed planar side walls to selectively vary the effective width of the outlet opening.

13. The adjustable nozzle of claim 12, wherein the first and second spray adjustment arms are pivotally mounted at the upstream ends thereof to the first and second side walls, respectively.

14. The adjustable nozzle of claim 13, wherein the first and second spray adjustment arms include first and second guide surfaces that face the center of the fluid flow path; the guide surfaces positioned in the terminal segment to contact fluid flowing through the terminal segment and define the effective width of the outlet opening.

15. The adjustable nozzle of claim 14, wherein the guide surfaces are flat.

16. The adjustable nozzle of claim 14, wherein the guide surfaces are curved in a width direction.

17. The adjustable nozzle of claim 14, wherein the guide surfaces are shaped to transition in a downstream direction from a flat contour to a curved contour in a width direction.

18. The adjustable nozzle of claim 14, wherein the nozzle body includes at least one stop, and the rotatable collar includes at least one radially extending boss that limits rotation of the adjustable collar relative to the nozzle body to a preselected amount.

19. The adjustable nozzle of claim 12, wherein the first and second spray adjustment arms engage an eccentric groove formed in the actuator, such that the rotation of the actuator causes the eccentric groove to move relative to the first and second spray adjustment arms, thereby pivoting the first and second spray adjustment arms toward and away from the first and second side walls, respectively.

20. A method of varying a width of an oblong stream of fluid exiting an oblong outlet opening in an outlet section of a nozzle body, the method comprising:
actuating an adjustment collar of an actuator to displace an adjustable spray restrictor segment toward and away from a center of a fluid flow path through the nozzle body, thereby varying an effective width of the oblong outlet opening to vary a pattern of fluid flowing from the fluid flow path through the outlet opening.

21. The method of claim 20, wherein actuating the adjustment collar includes pivoting first and second opposed spray adjustment arms attached to the outlet section and extending into the fluid flow path toward and away from the center of the fluid flow path, thereby varying the effective width of the oblong outlet opening to vary the width of the rectangular stream of fluid from the outlet opening.
